(19) United States
(12) Patent Application Publication
(10) Pub. No.: US 2004/0024822 A1
(43) Pub. Date: Feb. 5, 2004

(54) Apparatus and method for generating audio and graphical animations in an instant messaging environment

(76) Inventors: Scott M. Werndorfer, Brookfield, CT (US); Kevin W. Kurtz, Bethel, CT (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/211,223

(22) Filed: Aug. 1, 2002

(51) Int. Cl. G06F 15/16

(52) U.S. Cl. 709/206

(57) ABSTRACT

A computer-implemented method is described comprising: associating a first sound with a first character string on an instant messaging client; monitoring incoming or outgoing instant messages for the first character string; and upon detecting the first character string, generating the sound on the instant messaging client.

### PRIORITY

This application is related to an application entitled “SYSTEM AND METHOD FOR MANAGING CONTACTS IN AN INSTANT MESSAGING ENVIRONMENT,” Ser. No. ______, Filed Jul. 29, 2002.

### BACKGROUND

1. Field of the Invention

The invention relates generally to the field of data communication systems. More particularly, the invention relates to a system and method for generating audio and animated graphics in an instant messaging environment.

2. Description of the Related Art

Instant messaging systems provide for live, text-based chat sessions between two or more users. Unlike e-mail, instant messaging requires that all parties be online at the same time. AOL's Instant Messenger (“AIM®”), Microsoft Network Messenger Service (“MSNMS®”), ICQ® and Yahoo! Messenger® are the major instant messaging services.

Instant messaging clients allows users to maintain a list of contacts, often referred to as a “buddy list” or “contact list.” A user can send instant messages to any of the people in the user's list, as long as those people are online. Sending a message opens up a small window where the user and the user's buddies can type in messages that both can see.

Most of the popular instant messaging programs provide a variety of supplemental features including, for example, Web links ( the ability to share links to Websites); image sharing (the ability to view images stored on a buddy's computer; sound sharing (the ability transmit sounds to a buddy); file sharing (the ability to transmit files to a buddy); audio communication (the ability to use the Internet instead of a phone to actually talk with buddies); and information streaming (streaming of real-time or near-real-time information such as stock quotes and news headlines).

Some of the basic principles associated with an instant messaging session will now be described with respect to FIG. 1. In order to establish an instant messaging session, client computers 102 and 104 operated by end users, must initially connect over a network (e.g., the Internet) to an instant messaging service 100. The client computers 102 and 104 typically establish a connection via a dial up line, cable modem connection or digital subscriber line (“DSL”). Alternatively, the client computers 102 or 104 may be connected to the Internet via a local area network (“LAN”) gateway.

In order to communicate with the specified instant messaging service 100, proprietary instant messaging client software must initially be installed on the client computers 102 and 104. For example, if the instant messaging service 100 is AIM, then AOL's proprietary instant messaging client software must be installed. The client software allows the client computers 102 and 104 to communicate with the AIM server using AOL's proprietary instant messaging protocol.

Similarly, other instant messaging services, such as IM service 108, will require different client software installed on client computers 106 and 110. For example, Yahoo's proprietary IM software, which includes built-in support for Yahoo's proprietary IM protocol, must be installed on any client computer that uses Yahoo's IM service. Moreover, the client IM software and associated IM protocols required by each service 100, 108 are not compatible. Client software designed for one service may not be used to connect to a different service.

Once the IM client software is installed, to establish an IM session, the client sends the IM service connection information associated with the client computer (e.g., IP address and port number). The IM service creates a temporary file that contains the connection information for the user and the contacts in the user's buddy list. It then checks to see if any of the contacts in the buddy list are currently logged in.

If the service locates any contacts logged in, it sends the connection information for those contacts back to the client. The IM service also sends the user's connection information to the contacts in the buddy list that are signed on. When the client receives the connection information for a contact in the buddy list, it changes the “status” of that person to “Online.” The user may then click on a name of any contact in the buddy list who is online, opening an IM window in which the user may enter an instant message.

Once the users have signed on to the IM service, all subsequent communication may occur directly between the two clients, as indicated by the “direct link” between clients 102 and 104, and clients 106 and 110. However, in some circumstances, IM communication must continue to occur through the instant messaging service 100. For example, if client 104 is behind a firewall, client 102 may not be permitted to establish an IM session with client 104 directly.

When the user goes “offline” the client sends a message to the IM server to terminate the session. The server then sends a message to the clients of each contact in the user's buddy list who are currently online to indicate that the user has logged off. Finally, the IM server deletes the temporary file that contained the connection information for the client(s).

### SUMMARY

A computer-implemented method is described comprising: associating a first sound with a first character string on an instant messaging client; monitoring incoming or outgoing instant messages for the first character string; and upon detecting the first character string, generating the sound on the instant messaging client.

### BRIEF DESCRIPTION OF THE DRAWINGS

A better understanding of the present invention can be obtained from the following detailed description in conjunction with the following drawings, in which:

FIG. 1 illustrates the basic principles associated with current instant messaging systems.

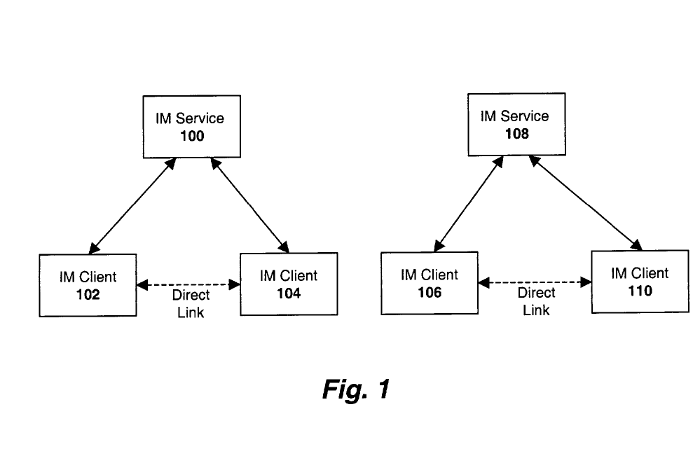

FIG. 2 illustrates an instant messaging client architecture according to one embodiment of the invention.

FIG. 3 illustrates an instant messaging GUI according to one embodiment of the invention.

FIG. 4 illustrates a service-based menu according to one embodiment of the invention.

FIG. 5 illustrates a connection manager according to one embodiment of the invention.

FIG. 6 illustrates the creation of a meta contact according to one embodiment of the invention.

FIG. 7 illustrates a pop-up information screen associated with a meta contact.

FIG. 8 illustrates an instant messaging text entry window according to one embodiment of the invention.

FIG. 9 illustrates a meta contact menu and a screen name selection menu employed in one embodiment of the invention.

FIG. 10 illustrates one embodiment of a logical architecture for implementing meta contacts.

FIG. 11 illustrates a plugin selection window according to one embodiment of the invention.

FIG. 12 illustrates plugin sections employed within an instant messaging client window.

FIG. 13 illustrates additional plugin sections employed within the instant messaging client window.

FIG. 14 illustrates an architecture for implementing aliases and word replacement according to one embodiment of the invention.

FIG. 15 illustrates a preferences window for entering alias settings according to one embodiment.

FIG. 16 illustrates a window for entering word match settings according to one embodiment of the invention.

FIG. 17 illustrates an input window for adding events according to one embodiment of the invention.

FIG. 18 illustrates a general events window according to one embodiment of the invention.

FIG. 19 illustrates an advanced events window according to one embodiment of the invention.

FIG. 20 illustrates an event monitoring module according to one embodiment of the invention.

FIG. 21 illustrates a window for selecting default away messages or entering custom away messages according to one embodiment.

FIG. 22 illustrates some of the basic concepts associated with emoticons in an instant messaging environment.

FIG. 23 illustrates emotisounds employed in one embodiment of the invention.

FIG. 24 illustrates an architecture for implementing emotisounds and animated emoticons according to one embodiment of the invention.

FIG. 25 illustrates a container window according to one embodiment of the invention.

FIG. 26 illustrates one embodiment of a process for manually generating a new container window.

FIG. 27 illustrates one embodiment of a process of automatically generating a new container window.

FIG. 28 illustrates additional window settings employed in one embodiment of the invention.

FIG. 29 illustrates a TCP packet containing instant messaging data for a particular instant messaging service.

FIG. 30 illustrates the manner in which a standard, service-specific type field is modified for secure instant messaging according to one embodiment of the invention.

### DETAILED DESCRIPTION OF PREFERRED EMBODIMENTS

As described above, one of the problems associated with instant messaging is the lack of interoperability between the different instant messaging services. For example, a different, proprietary IM client must be installed for each individual IM service on which the user opens an account. Downloading, installing and coordinating among a plurality of different, incompatible IM clients may consume a significant amount of time and effort on behalf of the user.

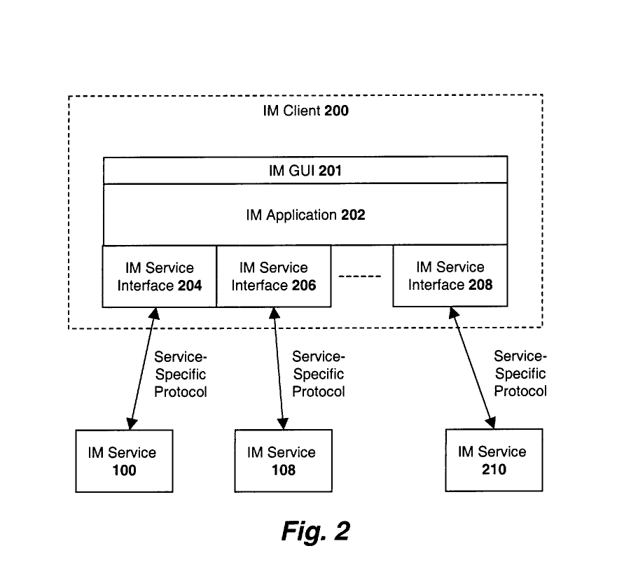

To solve this and other problems, the assignee of the present application has developed a unified instant messaging client platform which is interoperable with each of the different IM services. Referring to FIG. 2, the IM client platform 200 is comprised generally if an IM application portion 202, which contains standard IM functions used by each IM service 100, 108, 210 (e.g., a buddy list, user-defined online/offline parameters, and other universal IM features described below). Users interact with the IM application 202 via an IM graphical user interface (“GUI”) 201, various features of which are described below. Finally, in order to provide interoperability with the different, normally incompatible, IM services, an IM service interface module 204, 206, 208 is provided for each IM service 100, 108, 210, respectively. The IM service interface modules 204, 206, 208 provide service-specific features and communicate with the respective IM services 100, 108, 210 using the IM protocol required by that service. For example, if IM service 100 is AOL, then IM service interface 204 communicates using AOL's proprietary instant messaging protocol. The various service-specific protocols are employed by the IM client 200 transparently to the end user. In sum, the architecture illustrated in FIG. 2 allows a user to access accounts on different instant messaging services using a unified IM application 202 and a consistent graphical user interface 201.

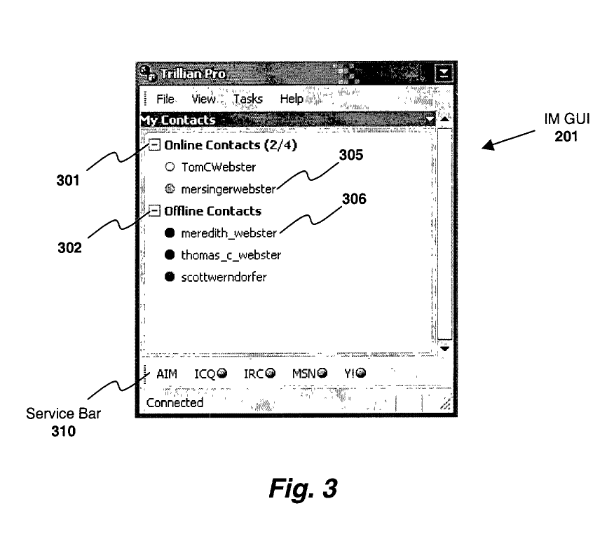

One embodiment of the instant messaging GUI 201 is illustrated in FIG. 3. The GUI 201 is comprised of a buddy list which, like other IM buddy lists, is separated into a list of online contacts 301 and a list of offline contacts 302. Unlike prior buddy lists, however, the buddy lists illustrated in FIG. 3 may include contacts from various different IM services. For example, the contact entries “MerSingerWebster” 305 and “Meredith_Webster” 306 may be screen names for the same individual on different IM services (e.g., AOL and Yahoo). In the particular example shown in FIG. 3, the individual is registered as online on one account (MerSingerWebster 305) and offline for the other account (Meredith_Webster 306).

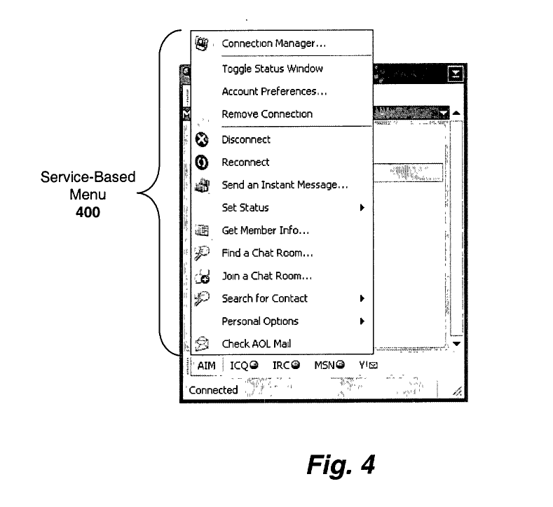

In order to coordinate among the various IM services, a service bar 310 is provided which includes a set of graphical buttons representing each of the different services. The user may connect to a particular service and/or access/modify the features provided by that service by selecting the button corresponding to the service. By way of example, in FIG. 4, the user has selected the AIM button, bringing up a service-based menu 400 which includes settings/preferences for AOL's IM service. The options available on the menu may change from one button to the next, based on the options available for each service.

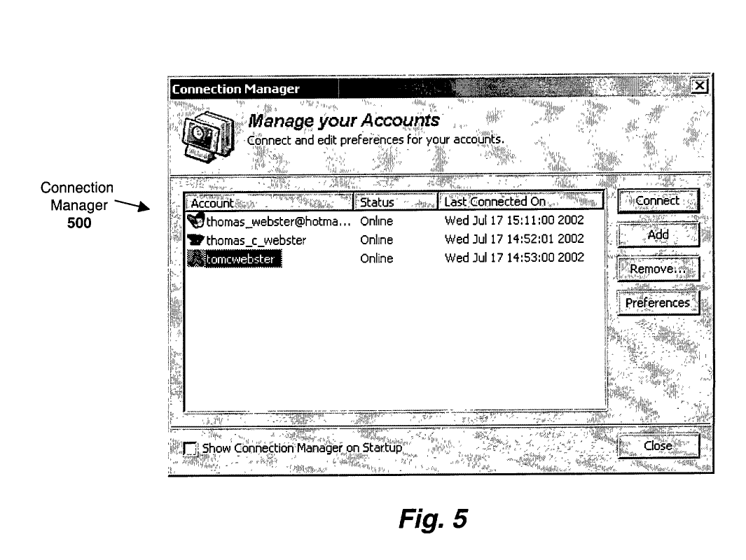

The user may connect to multiple services at once, using one or more different screen names. However, in one embodiment, if the user is not logged in to a particular service, the only option which will be provided via the service bar is the “connection manager” option (shown at the top of the menu in FIG. 4). Selecting this option will bring up a connection manager window 500, such as that shown in FIG. 5, which provides a list of all services on which the user has an account. In the particular connection manager window 500 illustrated in FIG. 5, the user has set up accounts for Microsoft, Yahoo! and AOL. From the connection manager window 500, the user may connect to the various IM accounts, add new accounts, delete accounts, and modify preferences for each account.

One embodiment of the GUI 201 provides the user with the option to “globally connect” or “globally disconnect” from each service on which the user has an account, thereby streamlining the process of connecting/disconnecting to multiple services. Similarly, one embodiment provides the user with the option to globally set his/her online status to “globally away” or “globally back.” Each of the global functions may be provided within the IM application 202. The IM service interfaces 204, 206, and 208 may translate the global functions to service-specific functions, interpretable by each individual service 100, 108, and 210, respectively. Global functions may be provided as menu entries within the GUI menu structure (e.g., File, and/or may be triggered via certain specified hotkeys (e.g., CTRL+D=global disconnect, . . . etc).

### Meta Contacts

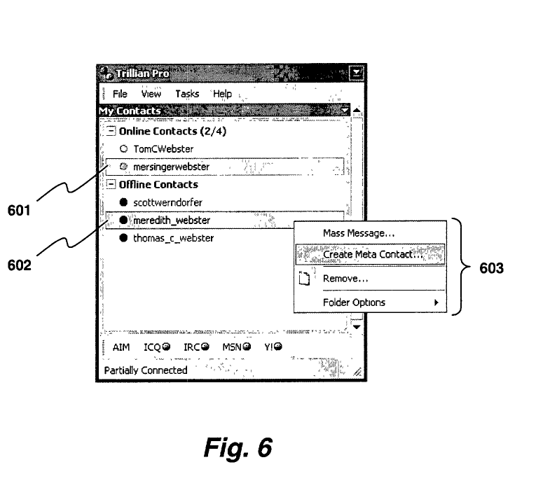

In order to simplify the process of managing contacts from multiple IM accounts, one embodiment of the invention allows the user to set up a group of screen names which represent a single user. These groups will be referred to herein as “Meta Contacts.” The process of creating and working with Meta Contacts will now be described with reference to FIGS. 6-9.

Two of the contact names displayed in FIG. 6, “mersingerwebster” 601 and “meredith_webster” 602, represent the same individual on two different services (e.g., AOL and Yahoo!). In one embodiment of the invention, in order to combine these two contact names into a single Meta Contact, the user initially highlights both names and then right-clicks (i.e., select the right mouse button) on one of the highlighted names using a mouse pointer or other graphical input mechanism. Of course, various alternate input mechanisms (i.e., other than a “right-click”) may be employed while still complying with the underlying principles of the invention. Right-clicking in this manner will bring up a menu 603, which includes an option to send a mass message or to create a Meta Contact. Selecting the Mass Message option allows the user to send an instant message to the group of highlighted contact names—in this case, the same individual. Selecting the Create Meta Contact option brings up a screen (not shown) in which the user is prompted to enter the name of the new Meta Contact.

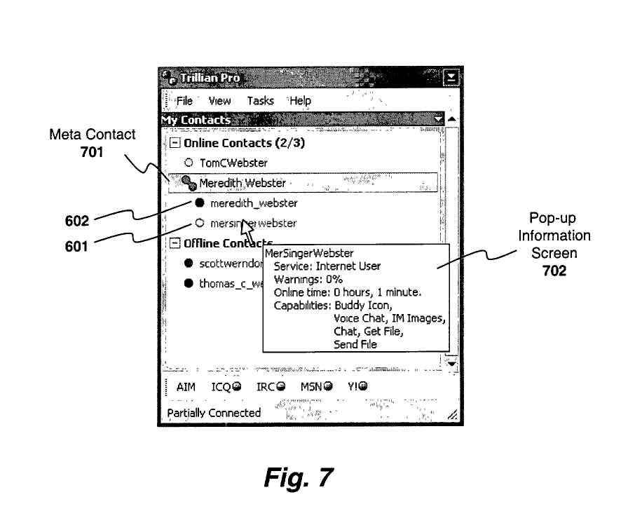

After the user enters the name for the new Meta Contact, the name “Meredith Webster” 701 appears in the user's buddy list as illustrated in FIG. 7. In one embodiment of the invention, as the user drags a mouse pointer (or other graphical selection element) over the Meta Contact 701, the individual contact names 601-602 appear beneath the Meta Contact as indicated. In addition, dragging the mouse pointer over one of the individual contact names then brings up a pop-up information screen 702 which displays information related to the contact including, by way of example but not limitation, the online status of the contact (e.g., how long the contact has been online) and the instant messaging features available to the contact (e.g., those supported by the contact's IM service). Various additional contact-related information may be provided in the pop-up information screen 702 while still complying with the underlying principles of the invention.

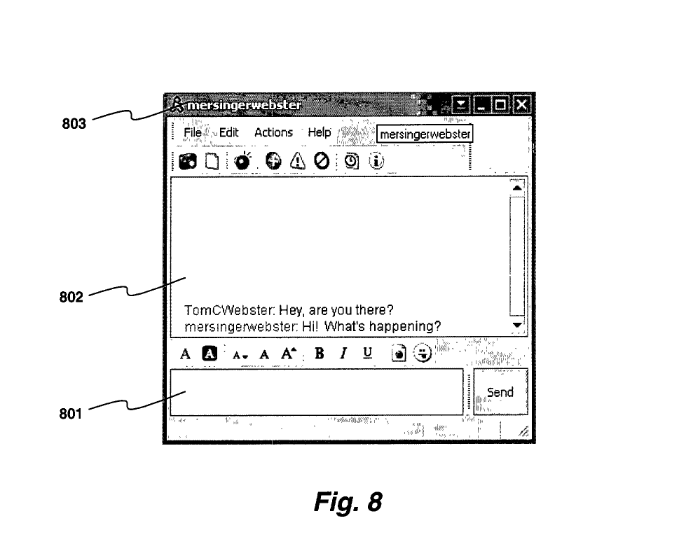

In one embodiment, to send an instant message to the individual represented by the Meta Contact 701, the user clicks on the Meta Contact 701 in the same manner as if the user were sending an instant message using a standard contact name. After clicking on the Meta Contact 701, a window such as that shown in FIG. 8 appears, comprised of a text entry region 801 in which the user may enter the instant message, and an IM conversation window 802 in which the complete IM conversation between the user and the selected contact appears.

In the illustrated example, only one of the two IM accounts organized within the Meta Contact 701 is selected for the IM session, as indicated in the title bar 803. In one embodiment of the invention, a user-configurable prioritization scheme is employed to determine which IM account 602, 602 (or group of accounts) within the Meta Contact 701 to select for the IM session. In one embodiment, the initial prioritization is based on the order in which the contact names 602, 601 appear under the Meta Contact heading 701. Using this scheme, the contact name “meredith_webster” 602 would be selected initially over the contact name “mersingerwebster” 601, with all other variables being equal. In one embodiment of the invention, the user may select and drag a contact name to a different position in the list to modify the initial priority scheme (e.g., contact name 601 may be moved above contact name 602). It should be noted, however, that various alternate techniques for determining priority may be employed (i.e., other than mere positioning within the Meta Contact list) while still complying with the underlying principles of the invention.

In one embodiment, a relatively higher priority IM account will be passed over in favor of a relatively lower priority IM account if the user registered as “offline” on the higher priority account and “online” or “idle” on the lower priority account. Thus, in the example illustrated in FIG. 7, if contact 601 is registered online and contact 602 is offline, then contact 601 will be selected, notwithstanding the fact that it is positioned beneath contact 602 in the user's contact list. In one embodiment, any contact names registered as “online” with their respective IM services are highlighted to indicate an online status.

Various additional user-configurable Meta Contact parameters may be employed to select a particular contact name/IM account. For example, in one embodiment, the user may configure the system to transmit instant messages to any of the accounts on which the contact is registered as “online.”

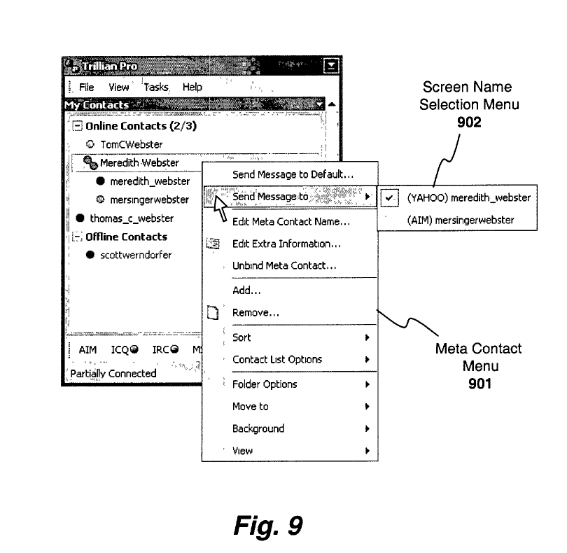

As illustrated in FIG. 9, in one embodiment, the user may right click (or perform another designated input function) to bring up a Meta Contact control menu which allows the user to control/configure the various Meta Contact functions. The user may choose to send a message to the default contact within the Meta Contact list (e.g., using the prioritization scheme described above). Alternatively, the user may specify a particular contact name/IM account to which an instant message should be transmitted. This option (which is highlighted in FIG. 9), brings up a secondary window 902 which includes each of the Meta Contact names from which the user may manually select.

Other noteworthy options within the Meta Contact menu 901 include the ability to edit/add information related to the contact (e.g., in a text format). In one embodiment, this additional information will appear in the pop-up information screen 702 illustrated in FIG. 7. In addition, the Meta Contact menu 901 includes the option to sort contacts based on different variables (e.g., alphabetically, reverse alphabetically, based on medium, based on status, . . . etc); as well as the ability to modify various contact list options.

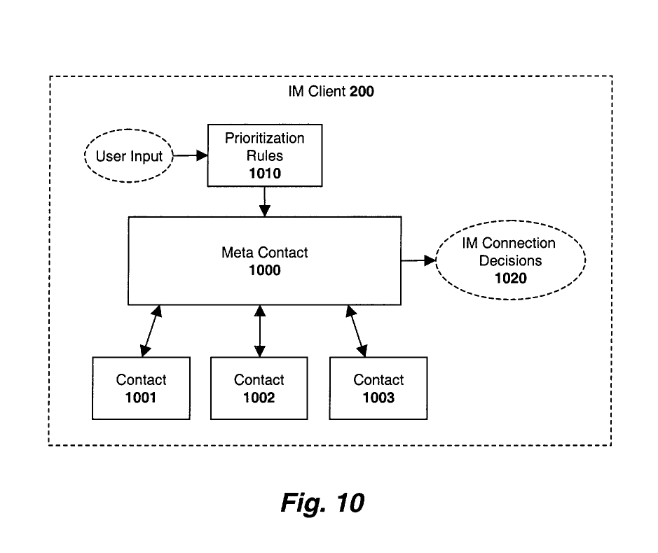

A logical architecture for implementing the Meta Contact features described above is illustrated generally in FIG. 10. A Meta Contact module 1000 logically groups a plurality of individual contact data objects 1001-1003, each of which represents an account on a different IM service. The Meta Contact module 1000 makes IM connection decisions 1020 based on a set of user-configurable prioritization rules 1010 (e.g., such as those described above with respect to FIGS. 6-9).

In one embodiment, the generalized architecture illustrated in FIG. 10, as well as the other instant messaging features described throughout this application, are implemented in software executed by a general purpose processor (e.g., an Intel Pentium®-class processor). More specifically, in one embodiment, the various IM features described herein are programmed using the Extensible Markup Language (“XML”). It should be noted, however, that the particular programming language employed is not pertinent to the underlying principles of the invention. Moreover, the invention may be embodied in hardware, software, firmware and/or any combination thereof.

### Plugins, Sections and Aliasing

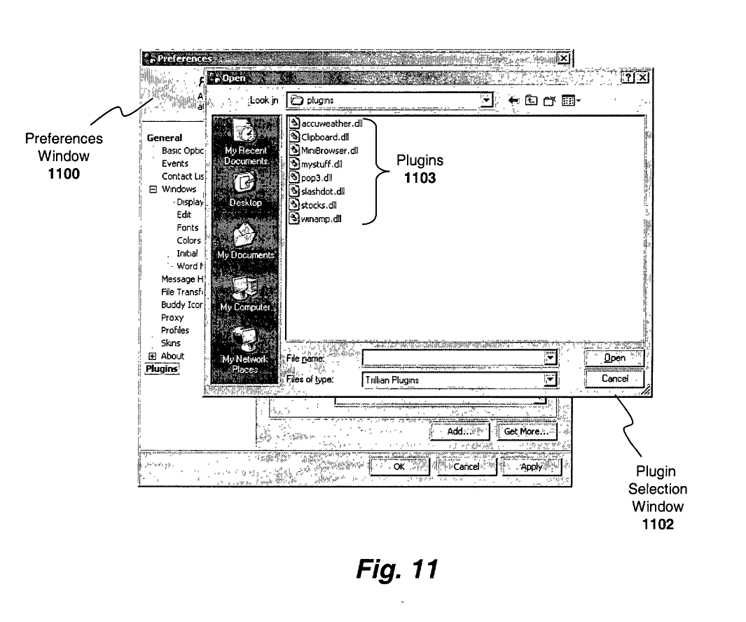

One embodiment of the invention provides an application programming interface for plugins—i.e., supplemental programs which provide the primary IM client 200 with additional features. As illustrated in FIG. 11, new plugins 1103 may be installed via a plugin selection window 1102, generated by selecting the “plugins” option from the IM client's preferences window 1100.

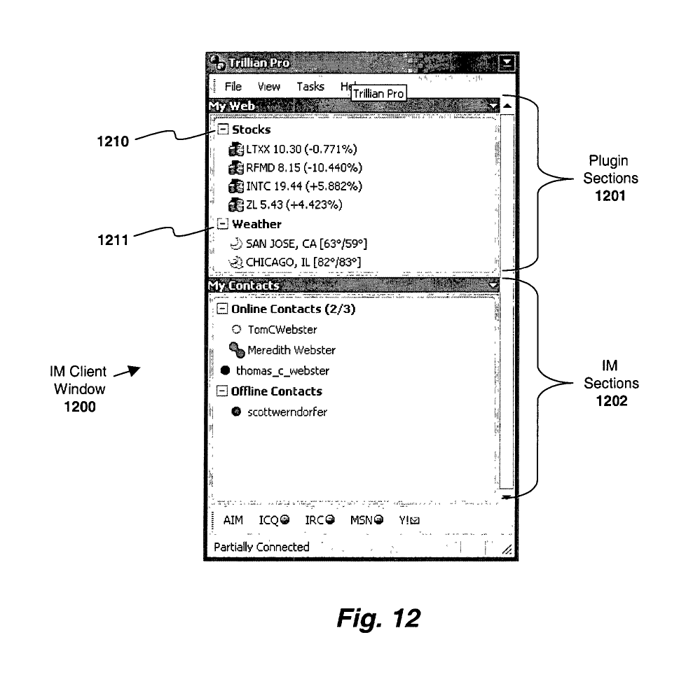

As illustrated in FIG. 12, when new plugins are installed, subwindows, referred to herein as “sections,” are generated within the primary IM client window 1200. The plugin sections 1201 illustrated in FIG. 12 include a stock ticker 1210 and weather 1211. The particular stock information and weather forecast information to be collected by the IM client 200 are selected by the user at the time the plugin is installed or at any time thereafter. In one embodiment, once the user specifies the information to be displayed, the IM client 200 downloads and continually refreshes the information from a particular source on the Web (e.g., Yahoo!, Accuweather, . . . etc).

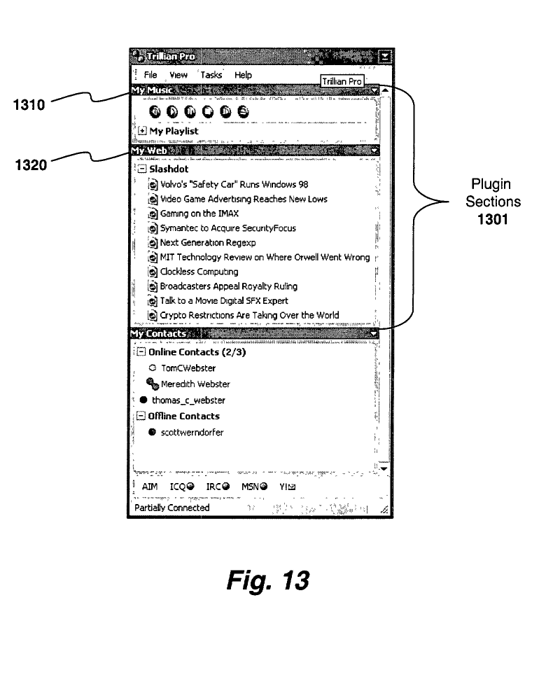

FIG. 13 illustrates two additional types of plugins 1301. A news plugin 1320 continually retrieves up-to-date news headlines from a specified news source (e.g., a Web server) and a music plugin 1310 provides a graphical interface for playing/recording music selections via the IM client 200 (e.g., MP3 files). In one embodiment, the music plugin employs a third party music player to play/record the user's music selections such as, for example, Winamp.

Various additional plugins sections are contemplated within the scope of the present invention, including, for example, a mini Web browser section for browsing the Internet from within the IM client and a mail section for periodically downloading e-mail messages from the user's e-mail account (e.g., using the POP-3 protocol).

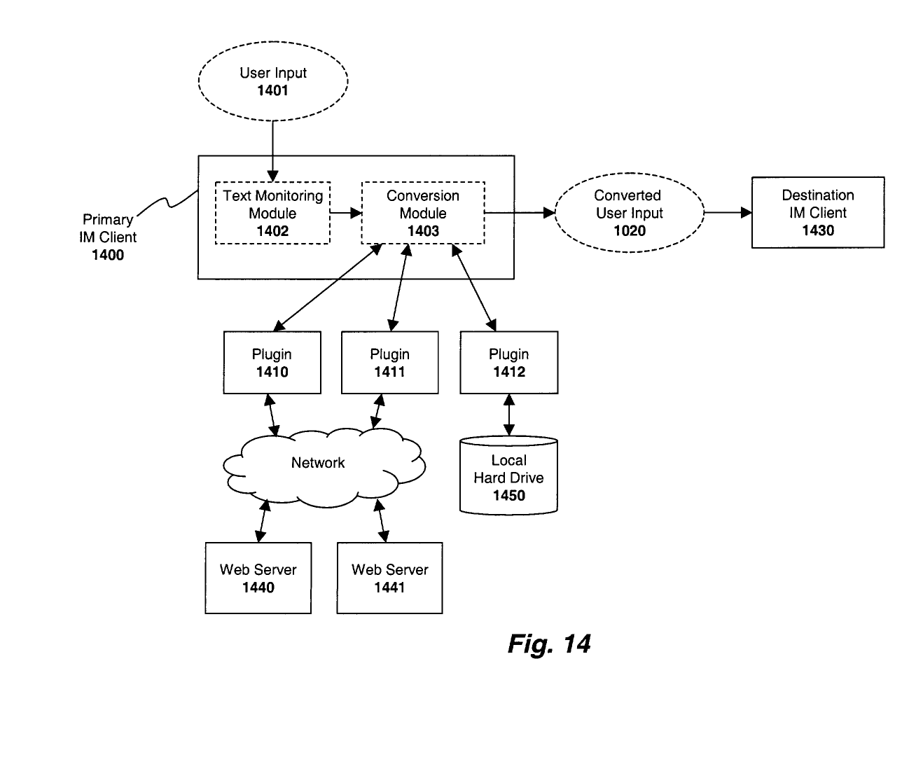

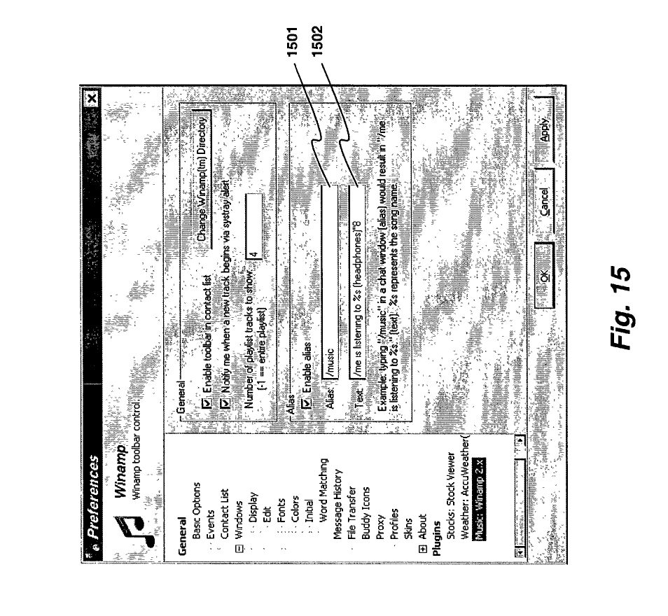

Referring now to FIGS. 14 and 15, in one embodiment, the user may direct the IM client 200 to transmit section-related information to a contact. As illustrated, plugins 1410-1412 may be configured to download and display user-specified information from Web servers 1440 and 1441, respectively. Plugin 1412 processes and displays information stored on a local hard drive 1450 (e.g., local music files). The underlying principles of the invention remain the same regardless of how/where the plugins acquire the user-specified information.

In addition, in the embodiment illustrated in FIG. 14, the primary IM client 1400 is comprised of a text monitoring module 1402 and a data conversion module 1403. The text monitoring module 1402 monitors the character sequences input by the user into the text entry region 801 of the IM window. Certain characters or groups of characters may be designated as control characters. When the text monitoring module 1402 detects a control character or a group of control characters, it triggers a content conversion module 1403 to modify/supplement the user's input in one or more specified ways, some examples of which are set forth below. The converted user input 1020 is then transmitted in an instant message to one or more destination IM clients 1430.

For example, in one embodiment, any characters which directly follow the “/” character are interpreted by the text monitoring module 1402 as an “alias.” As used herein, an alias identifies data maintained by one of the plugins 1410-1412, which is then inserted into the instant message by the content conversion module 1403. For example, as indicated in data fields 1501 and 1502 in FIG. 15, when the text monitoring module detects the alias “/music,” it triggers the content conversion module 1403 which replaces “/music” with the string of text “/me is listening to %s.” The content conversion module then replaces “/me” with the user's name and “%s” with the name of the MP3 track (or other type of music track) that the user is currently listening to (e.g., “Meredith Webster is listening to Tangerine”). The name of the MP3 track is extracted from the music plugin (e.g., plugin 1412) installed and executed on the IM client 200. Additional aliases may be created to transmit various user-specified data to IM recipients (e.g., “/news” to indicate a news story, “/stock” to transmit stock quotes for the user's portfolio, “/video” to indicate the program that the user is currently watching, . . . etc). It should be noted, however, that the underlying principles of the invention are not limited to any particular type of alias or any particular type of user-specified data.

In addition to (or in lieu of) using “aliases,” the user may configure the IM client to reformat and/or replace various specified character strings. For example, when the user types his/her screen name, he/she may want it to appear in bolded or italicized characters. Similarly, the user may want to trigger some sort of event in response to a particular character string (e.g., playing of a .WAV file, execution of a program, . . . etc).

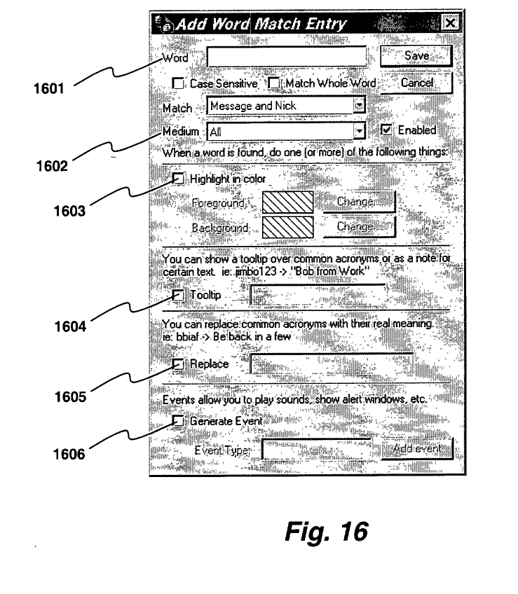

FIG. 16 illustrates one embodiment of a word match configuration window for performing these and other character formatting/substitution functions. The user may specify a character string via input field 1601. Upon detecting the specified character string, the text monitoring module 1402 will trigger the content conversion module 1403 to perform one or more actions, as specified in the remaining data fields. In data field 1602, the user may specify that the word match functions only apply to certain IM services. The default position is “All” wherein the word match functions are applied in the same manner for each service.

Selection box 1603 allows the user to specify a background and foreground highlight color for the selected text. Selection box 1604 allows the user to specify a tool tip note to be displayed above the character string. Section box 1605 allows the user to enter a character string to be used in place of the input character string. For example, the user's real name may be substituted for his/her screen name and certain acronyms may be replaced with the character string represented by the acronym (e.g., BTW=“By the way”).

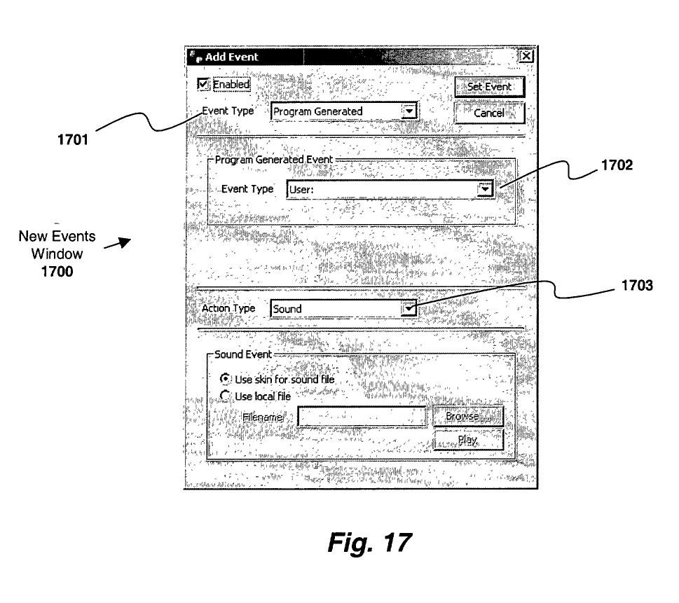

Finally, at 1606, the user may specify an event that will be triggered as a result of the text monitoring module identifying the specified character sting. Events may be programmed via the events window shown in FIG. 17. A variety of different events may be triggered in response to a particular character string including, by way of example but not limitation, generating a specified sound (e.g., identified as a .WAV file stored on a local storage device); executing a specified program or a specified program action (e.g., opening a picture of an individual identified by the character string); generating an alert window or a Systray alert (i.e., an alert appearing in the Windows system tray); and/or setting a user status (e.g., online to offline). Various other events may be programmed in response to specified character strings while still complying with the underlying principles of the invention.

### Event System

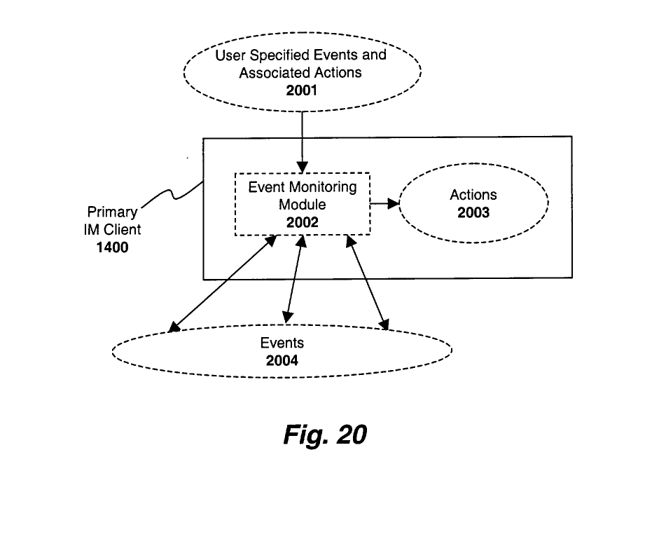

In addition to the event-based features described above with respect to the receipt of character strings, one embodiment of the invention employs a comprehensive event system for generating virtually any type of program action in response to virtually any type of events. One embodiment of the event system is illustrated generally in FIG. 20 in which, after a user specifies a set of events 2004 and associated actions 2003, an event monitoring module 2002 continually monitors the IM client 1400 to detect any of the specified events 2004. In response to detecting an event, the event monitoring module 2002 generates the specified action 2003 associated with that event.

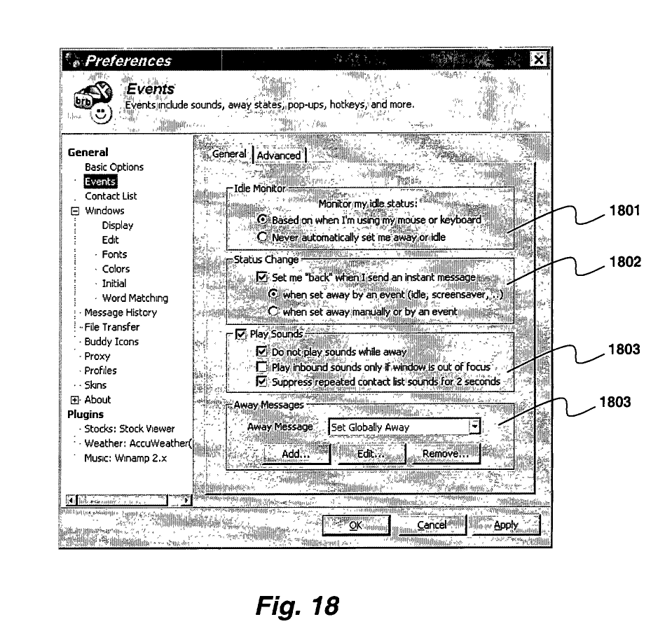

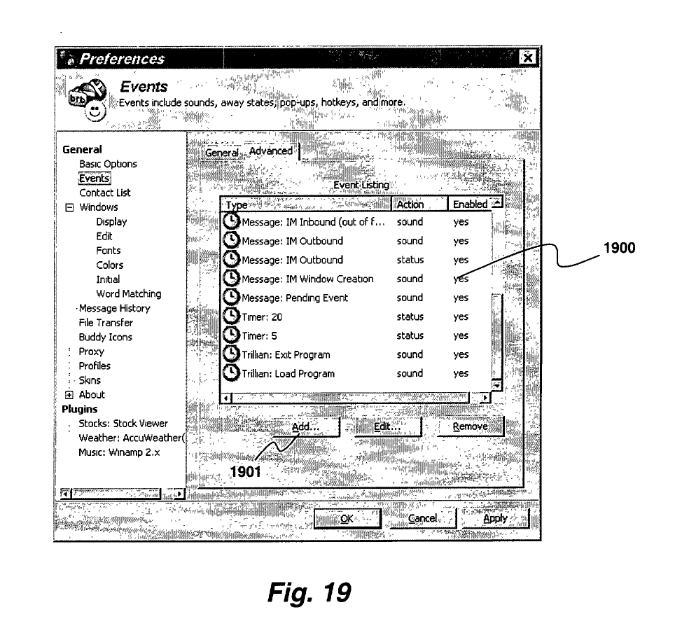

Two types of event selection windows are provided in the illustrated embodiment. A general event window is illustrated in FIG. 18 and an advanced event window is illustrated in FIG. 19. The general event window provides users with access to the most commonly-specified event types. For example, in region 1801, the user may configure the system to modify the user's status based on whether the user is actively using the mouse or keyboard. In one embodiment, if this option is selected, the user's status will change to “idle” after a first period of inactivity (e.g., 5 minutes) and then “offline” after a second specified period of inactivity (e.g., 20 minutes). The first and second periods of inactivity may also be specified by the user.

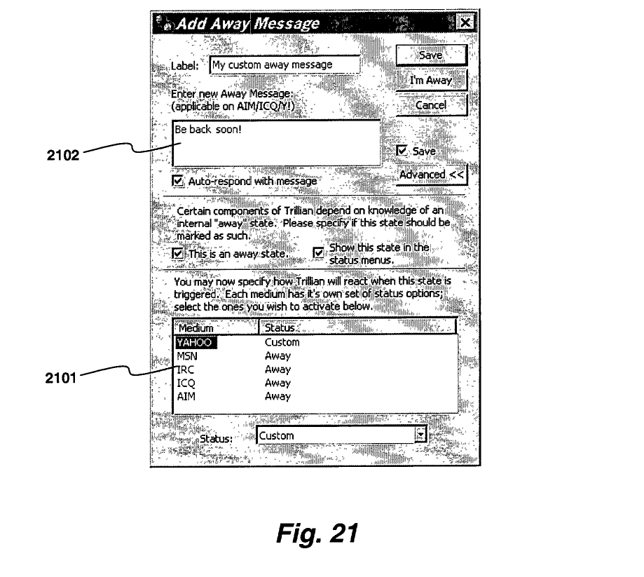

In region 1802, the user may select conditions under which the user's status should be set back to “online” (e.g., either when set away manually or by an event, or only when set away by an event). Region 1803 allows the user to configure various sound generation actions (as indicated) and region 1803 allows the user to customize away messages. In one embodiment, choosing to add a new away message brings up the window illustrated in FIG. 21. In region 2101, the user may specify that, for some IM services, the services' standard away message should be used whereas, for other IM services (e.g., Yahoo!, in the example) a customized away message should be used. The customized away message may be entered in region 2102, as illustrated.

FIG. 19 illustrates an advanced event window according to one embodiment of the invention. The event list shown in region 1900 displays each of the events programmed within the event monitoring module 2002, organized by event type. Associated with each event is a particular action as well as an indication as to whether the event is enabled. Selecting the add button 1901 brings up the new events window in FIG. 17.

In one embodiment of the invention, the following event types are supported: program generated events, idle time events, hotkey events, and scheduled events. Program events are events triggered by any function performed by the IM client 1400 or another external client/program. For example, a user may program the system to perform an action in response to the receipt of either a new instant message (internal) or a new e-mail message (external). In one embodiment, the user may program the event monitoring module 2002 to set the user's status as “offline” when the user's screen saver triggers.

Idle time events are events triggered after a predetermined amount of time that the user is inactive (e.g., not manipulating the mouse or keyboard). Hotkey events are triggered in response to the selection of a specified key or set of keys while the IM client is running (e.g., CTRL+M=create new instant messaging session). Finally, in one embodiment of the invention a scheduler is provided which allows the user to schedule actions at specified dates and times. The user may program the actions associated with scheduled events to trigger only once, daily, weekly, business weekly (e.g., Monday through Friday), monthly or yearly, to name just a few options.

As mentioned above, for each specified event, various types of actions may be selected within the action type region 1703 including, but mot limited to, generating a specified sound (e.g., from a .WAV file), executing a specified program (e.g., by identifying an executable file), generating an alert window or a Systray alert, and/or modifying the user's status. Once a new event and associated action is added to the system, it appears within the event list in region 1900.

### Emotisounds and Animated Emoticons

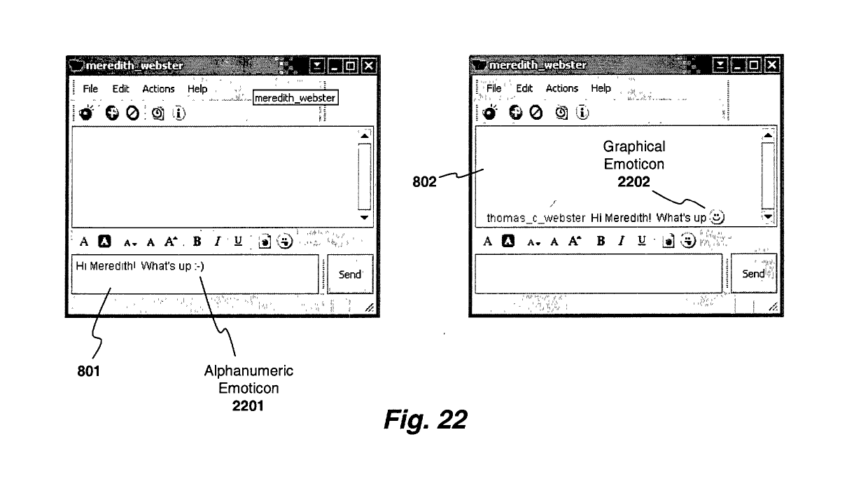

Emoticons are typewritten or bitmapped pictures used in instant messaging and e-mail applications to indicate expression. As illustrated in FIG. 22, many instant messaging systems will convert an alphanumeric sequence of characters 2201, entered within the IM text entry region 801, into a graphical (e.g., bitmapped) emoticon 2202 within the IM conversation window 802 of the destination IM client and the source IM client. In operation, the alphanumeric sequence 2201 is transmitted in a standard manner from the source IM client to the destination IM client. If the destination IM client has a graphical emoticon mapped to the alphanumeric sequence, it will display the graphical emoticon in lieu of the text within the IM conversation window 802.

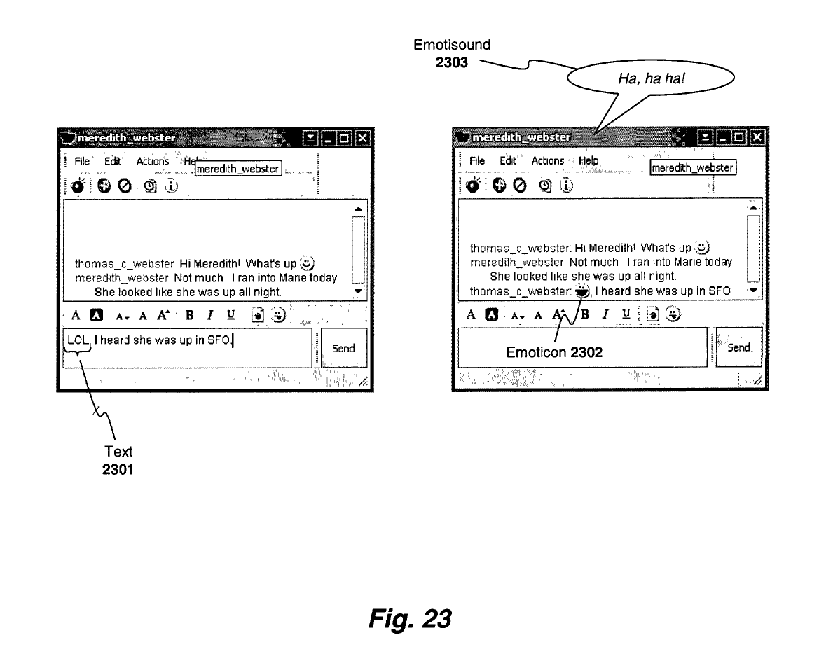

One embodiment of the invention provides support for “emotisounds” and “animated emoticons” in addition to standard graphical emoticons. As illustrated in FIG. 23, in response to a particular alphanumeric sequence 2310, a specified emotisound 2303 is generated at the destination IM client and/or the source IM client. In the specific example shown in FIG. 23, the alphanumeric sequence, LOL, stands for “laugh out loud.” As such, within the sequence generates both a laughing graphical emoticon 2302 and an audible laughing sound 2303 at the destination IM client and/or source IM client.

In one embodiment, the graphical emoticon 2303 is animated. That is, rather than producing a single, still graphical image within the IM conversation window 802, the IM client generates a sequence of graphical images within the window 802, resulting in an animation. For example, in FIG. 23, the sequence of images may produce the effect of a laughing emoticon 2303 in response to the “LOL” character sequence.

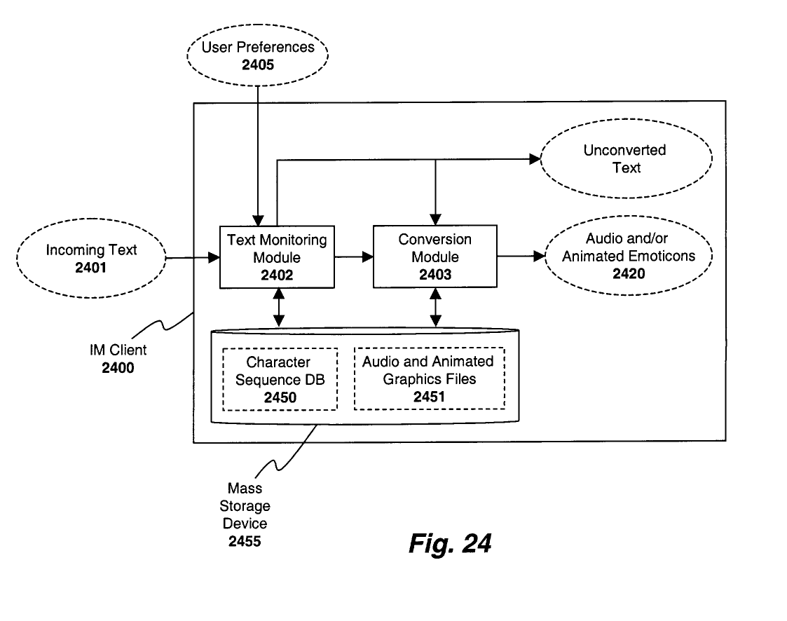

The emotisounds and animated emoticons may be identified and generated using a variety of techniques. One particular embodiment of an IM client architecture 2400 for implementing emotisounds and animated emoticons is illustrated in FIG. 24. A text monitoring module 2404 compares incoming character sequences against character sequences stored in a character sequence database 2450. If a particular character sequence is identified in the database, the text monitoring module 2404 performs a lookup on the client's mass storage device 2455 (e.g., a hard drive) to identify the audio and/or animated graphics files 2451 associated with the character sequence.

A content conversion module 2403 then incorporates the identified audio 2450 and/or animated graphics file 2451 represented by the character sequence into the instant message, resulting in emotisounds and/or animated emoticons 2420 such as that described above.

Various different audio and/or animation file types may be employed to generate the audio and/or animation. For example, the emotisounds may be stored as .WAV files, .MP3 files, ADPCM files, or using any other type of digital audio encoding. Similarly, the animations may be stored using any type of animation encoding including standard bitmap animation formats and/or vector-based animation formats (e.g., such as Macromedia Flash). One embodiment of the invention provides the user with the ability to program the text monitoring module 2402 and associated character sequence database 2450 and audio/animated graphics files 2451 with the user's own preferences 2405. For example, the user may generate his/her own sounds and animations and link the sounds/animations to specific character sequences. In one embodiment, the user may program contact-specific emotisounds and animated emoticons for each contact on the user's buddy list. For example, the user may link recorded audio content of the actual voice of each contact with character strings transmitted from the contact. For example, the user may configure the system to generate actual audio of the contact laughing in response to the LOL (“laugh out loud”) sequence. In one embodiment, if the user does not have a particular audio or animation file stored within the local set of audio and animated graphics files, the user may allow other users to transmit the audio and/or animation file via the instant messaging session.

Although described above in the contact of specific sounds and animations (e.g., LOL), it should be noted that the underlying principles of the invention are not limited to any particular sounds or animations. A virtually unlimited number of character sequences may be linked to an unlimited number of animations and/or sounds, limited only by the storage capacity of the IM client computer. Moreover, various other types of multimedia content and executable code may be invoked in response to designated character strings (e.g., digital video sequences).

### Container Windows

One embodiment of the invention allows the user to combine multiple IM sessions/windows within a single window, referred to herein as a “container window.” container windows allow several different IM sessions to be concurrently maintained without causing excessive desktop clutter.

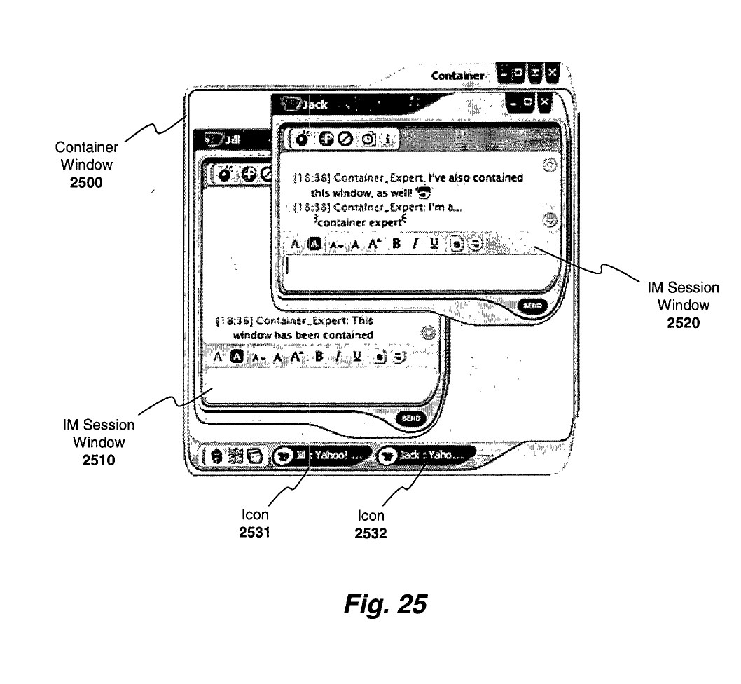

One embodiment of a container window 2500 is illustrated in FIG. 25. Two IM session windows 2510 and 2520 are contained within the container window 2500. It will be appreciated, however, that any number of additional IM session windows and/or alternate IM client windows (e.g., the primary IM client window) may be maintained within the container window 2500.

In one embodiment, a container window taskbar 2530 is provided at the bottom of the container window 2500. Taskbar icons 2531 and 2532 are provided on the container window taskbar 2530 for each IM session window 2510 and 2520 maintained within the container window, respectively, thereby freeing space on the primary OS taskbar for other applications (e.g., the Windows taskbar; not shown). In one embodiment, when a new instant message arrives in an IM session, the taskbar icon 2531, 2532 associated with that session flashes (or provides some alternate indication, to identify to the user that a new message has arrived).

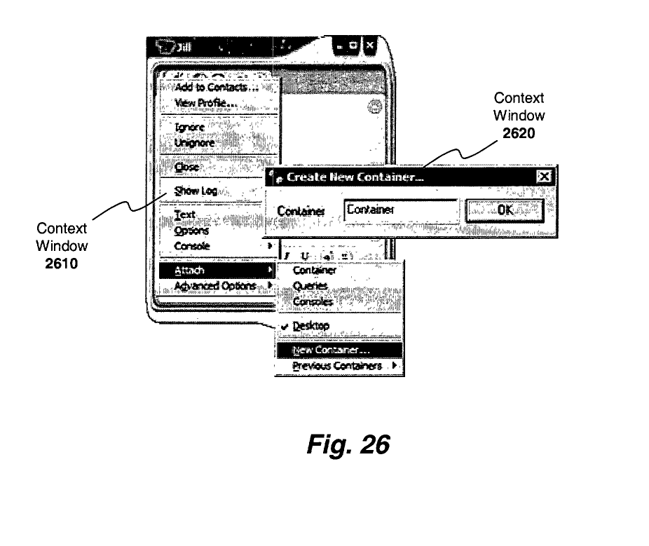

As illustrated in FIG. 26, in one embodiment, to create a container, a user generates a context menu 2610 and selects “Attach/New Container” (e.g., via a mouse or other cursor control device). The user is then presented with a dialog box requesting this new container's name. Once the user enters an appropriate container name, the new container is created.

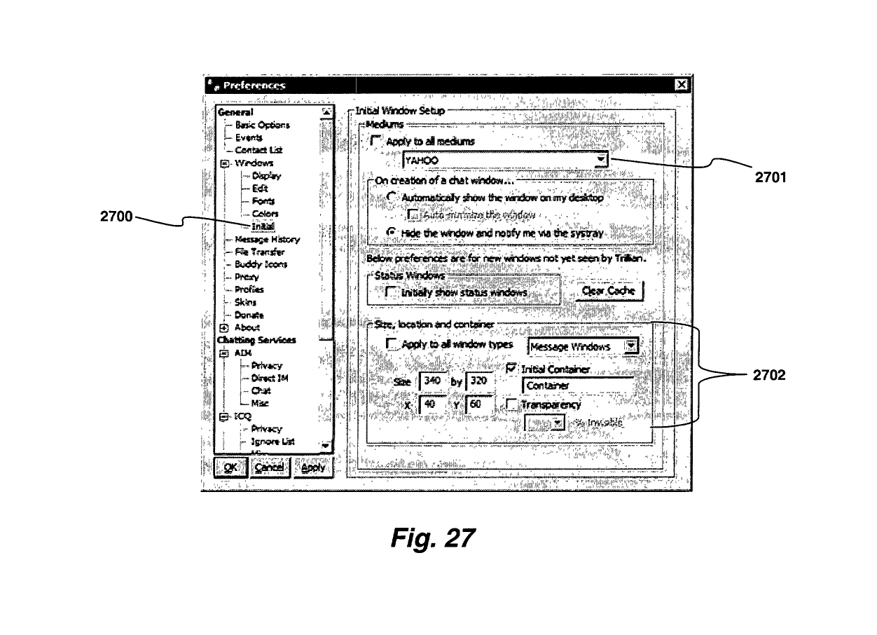

In addition to (or in lieu of) manual container attachment, one embodiment of the IM client provides for the automatic generation of container windows. As with other sections of the preferences window (see, e.g., FIG. 18), the Window/Initial section 2700 illustrated in FIG. 27 provides several ways to change initial window settings. In selection region 2701, initial window setting may be set globally, for all mediums, or only for specified mediums (e.g., only Yahoo). To apply an initial window setting for a specific medium, the “Apply to all Mediums” box must be unchecked, and the specific medium selected from the drop-down list shown in selection region 2701.

In the “Size, location and Container” section 2702 of the preferences window 2700, the user may choose between having container settings applied globally to all types of windows, or merely to specific types of windows. In one embodiment of the invention the different window types include message windows, channel windows and status windows.

All instant messaging conversations with contacts take place in message windows. On IRC, these windows are also referred to as “query windows,” and may consolidate many private messages to another user. Channel windows are used for IRC to convey conversations with many users (listed along the right side of the GUI) at once. In one embodiment, when a connection is created, all of the underlying technical information (e.g., status changes, incorrect password warnings, messages of the day, . . . etc) is sent to a sometimes hidden console window which may be viewed by selecting “Toggle Status Window” from a medium's menu on the contact list.

After choosing a type of window for automatic containment, the final step is to supply a name for the container. The user may select the “Initial Container” check box in section 2702, and type in a container name. In the example shown in FIG. 27, the IM client has been programmed to create an automatic containment of “Message Windows,” belonging to the Yahoo instant messaging service within a container named “Container.”

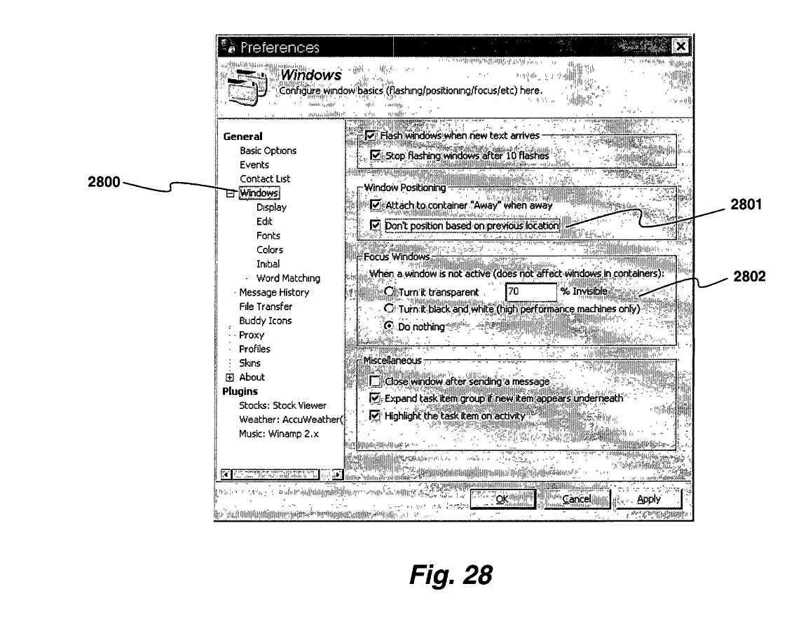

The IM client may be programmed to contain windows event if they have been previously used (i.e., it will not merely contain new windows). Referring to FIG. 28, in one embodiment, this is accomplished by selecting the General/Windows option 2800 and then the selection box 2801 indicating that windows should not be positioned based on their previous location. This option, when set, will instruct the IM client to disregard the previous container for windows. Instead, windows will always be contained based on the user's instructions.

### Transparent and Black & White IM Windows

In one embodiment of the invention, users may configure the IM client to become transparent or black and white. The user may manually set a transparency level by right-clicking on the upper left corner of the IM client window with a mouse and selecting a specified percentage from a configuration window (not shown) (e.g., 90%, 80%, 70%, . . . etc). The percentage represents the amount of the IM window which will be visible relative to the background of the IM window (e.g., the desktop wallpaper). For example, a percentage of 90% will cause the IM client to be 90% visible with 10% of the background showing through.

In addition, one embodiment of the IM client will become transparent or black & white under certain user-specified conditions. For example, referring again to FIG. 28, in selection region 2802, the user may indicate that, when a window becomes inactive (e.g., the user is offline from all supported IM accounts), it should turn transparent by a specified percentage. Alternatively, the user may indicate that the window should turn black and white under the same set of conditions. Similarly, in one embodiment, the IM window will become transparent/black & white when it is moved from the foreground to the background (e.g., when the user is working within another window).

### Secure Instant Messaging

One embodiment of the invention provides support for secure IM communication between two IM clients. For example, an asymmetric encryption technique, also known as a “public/private key” technique, may be used in which each IM client encrypts instant messages using the other client's public key. The destination IM client then uses it's private key to decrypt the encrypted messages.

In one particular embodiment, the Blowfish cipher developed by Counterpane Internet Security, Inc., is used. Blowfish is a block cipher that operates on 64 bit (8-byte) blocks of data. It uses a variable size key, but in one embodiment of the invention, 128-bit (16 byte) keys are used for strong encryption. Blowfish is an ideal cipher for IM applications, or other real-time applications, because it is one of the fastest block ciphers (i.e., it is faster than DES, and much faster than IDEA or RC2).

In order to provide secure communication between IM clients, encrypted instant messages must be passed through the various IM services. Given the fact that each service uses a proprietary IM protocol, some mechanism must be provided to seamlessly layer the IM encryption over the existing IM protocol.

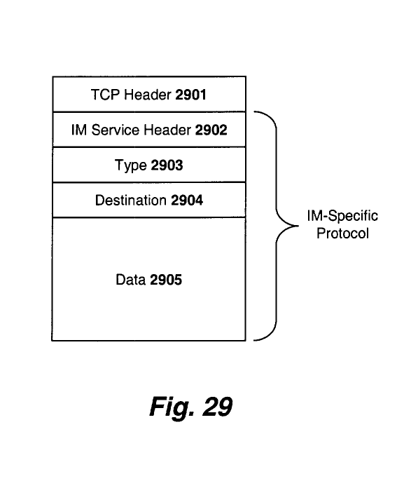

FIG. 29 illustrates a typical TCP packet containing instant messaging data. The TCP packet is comprised of a TCP header 2901 and instant messaging data fields 2902-2905 formatted according to the protocol used by the specified IM service. As illustrated, a typical IM data format includes an IM service header 2903, which indicates the particular service being used, and an IM type field 2904, which may be used in a variety of ways, depending on the IM service. For example, AOL uses the type field 2903 to indicate whether the message is a standard instant message, a buddy icon, a file transfer, . . . etc. Under the type field 2903 is a destination field 2904, which identifies the destination IM client, and a data field 2905 containing the underlying IM data (e.g., the actual instant message text).

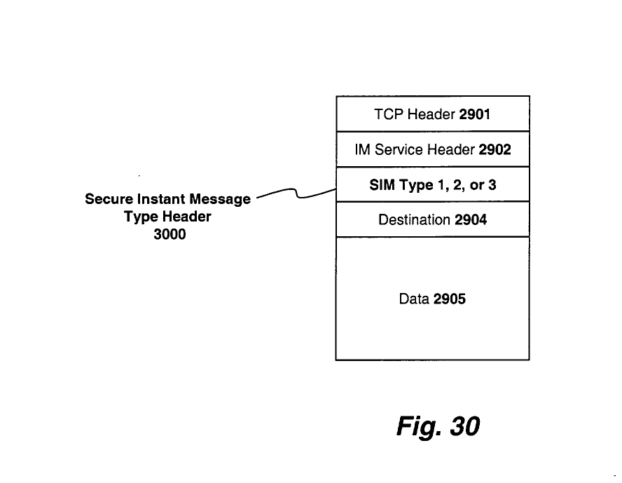

One embodiment of the invention uses the IM type field 2903 to provide information related to secure IM transactions. More specifically, as illustrated in FIG. 30, three different secure IM types are employed. “Type 1” indicates that the instant message is not encrypted; “Type 2” indicates that the IM data is encrypted using a particular encryption technique; and “Type 3” indicates that the packet contains a new key for the destination IM client to use to decrypt instant messages.

Accordingly, by layering an encryption protocol within an existing IM protocol used by a particular IM service, IM clients may conduct secure instant messaging sessions over services which do not normally support secure instant messaging.

Embodiments of the invention may include various steps as set forth above. The steps may be embodied in machine-executable instructions which cause a general-purpose or special-purpose processor to perform certain steps (e.g., on a client computer). Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Throughout the foregoing description, for the purposes of explanation, numerous specific details were set forth in order to provide a thorough understanding of the invention. It will be apparent, however, to one skilled in the art that the invention may be practiced without some of these specific details. For example, while the embodiments of the invention described above focus on a specific graphical user interface implementation for the IM client, various alternate interface types may be employed including text-based interfaces. In addition, although a client-based implementation is described above, a server-based implementation (or other distributed computing implementation) is also contemplated within the scope of the present invention. Accordingly, the scope and spirit of the invention should be judged in terms of the claims which follow.

What is claimed is:

1. A computer-implemented method comprising:
associating a first sound with a first character string on an instant messaging client;
monitoring incoming or outgoing instant messages for said first character string; and
upon detecting said first character string, generating said first sound on said instant messaging client.

2. The method as in claim 1 further comprising:
associating a graphical emoticon with said first character string; and
upon detecting said first character string, generating said graphical emoticon in an instant messaging session window.

3. The method as in claim 1 further comprising:
associating an animated emoticon with said first character string; and
upon detecting said first character string, generating said animated emoticon in an instant messaging session window.

4. The method as in claim 1 further comprising:
associating a graphical emoticon with a second character string; and
upon detecting said second character string, generating said animated emoticon in an instant messaging session window.

5. The method as in claim 1 further comprising:
associating a second sound with a second character string on said instant messaging client;
monitoring incoming or outgoing instant messages for said second character string; and
upon detecting said second character string, generating said second sound on said instant messaging client.

6. The method as in claim 1 wherein said character string has a context related to said first sound.

7. The method as in claim 1 wherein said first sound is a digital audio file stored on a hard drive local to said instant messaging client.

8. The method as in claim 7 further comprising:
receiving said first sound from a source instant messaging client and storing said first sound on said local hard drive.

9. The method as in claim 1 wherein the content of said first sound is related to a source instant messaging client from which said first character string was transmitted.

10. The method as in claim 9 wherein said content is a digitally recorded voice of a user of said source instant messaging client.

11. An instant messaging system comprising:
a character sequence database within which a plurality of character sequences are associated with a plurality of audio files;
a text monitoring module to monitor incoming or outgoing instant messages for one of said plurality of character strings and, upon detecting a first one of said plurality of character strings, to trigger a content conversion module to generate a first sound associated with said first character string on said instant messaging client.

12. The system as in claim 11 wherein a graphical emoticon is associated with said first character string within said character sequence database, and wherein upon detecting said first character string, said text monitoring module triggers said content conversion module to generate said graphical emoticon in an instant messaging session window.

13. The system as in claim 11 wherein an animated emoticon is associated with said first character string within said character sequence database, and wherein upon detecting said first character string, said text monitoring module triggers said content conversion module to generate said animated emoticon in an instant messaging session window.

14. The system as in claim 11 wherein a graphical emoticon is associated with a second character string within said character sequence database, and wherein upon detecting said second character string, said text monitoring module triggers said content conversion module to generate said animated emoticon in an instant messaging session window.

15. The system as in claim 11 wherein a second sound is associated with a second character string within said character sequence database and wherein upon detecting said second character string, said text monitoring module triggers said content conversion module to generate said second sound on said instant messaging client.

16. The system as in claim 11 wherein said character string has a context related to said first sound.

17. The system as in claim 11 wherein said first sound is a digital audio file stored on a hard drive local to said instant messaging client.

18. The system as in claim 17 wherein said first sound is received from a source instant messaging client and stored on a local hard drive.

19. The system as in claim 11 wherein the content of said first sound is related to a source instant messaging client from which said first character string was transmitted.

20. The system as in claim 19 wherein said content is a digitally recorded voice of a user of said source instant messaging client.

21. A computer-implemented method comprising:
associating a first animation with a first character string on an instant messaging client;
monitoring incoming or outgoing instant messages for said first character string; and
upon detecting said first character string, generating said first animation on said instant messaging client in an instant messaging session window.

22. The method as in claim 21 further comprising:
associating a second animation with a second character string; and
upon detecting said second character string, generating said second animation in an instant messaging session window.

23. The method as in claim 21 further comprising:
associating a first sound with a third character string on said instant messaging client;
monitoring incoming or outgoing instant messages for said third character string; and
upon detecting said third character string, generating said first sound on said instant messaging client.

24. The method as in claim 21 further comprising:
associating a first sound with said first character string on said instant messaging client; and
upon detecting said first character string, generating said first sound and said first animation on said instant messaging client.

25. A method implemented within a graphical user interface (“GUI”)on a computing system comprising:
displaying an application window in color responsive to said application window being executed as a foreground window; and
displaying said application window in back and white mode responsive to said application window being executed as a background window.

26. The method as in claim 25 wherein said application executed within said application window is an instant messaging application.

27. The method as in claim 26 further comprising:
changing said application window from color to black and white responsive to a user's instant messaging status changing from “online” to “offline.”

28. The method as in claim 26 further comprising:
displaying all other windows being executed as background windows in black and white.

29. The method as in claim 28 further comprising:
displaying only windows being executed as foreground windows in color.

30. The method as in claim 25 further comprising:
displaying said window being executed as a background window using a specified level of transparency.
